(19) United States
(12) Patent Application Publication
(10) Pub. No.: US 2005/0023101 A1
(43) Pub. Date: Feb. 3, 2005

(54) Ratchet pawl of flywheel

(76) Inventor: Tien Wang Hou, Taipei (TW)

Correspondence Address: HOU, Tien Wang, PO Box 82-144, Taipei, TW

(21) Appl. No.: 10/630,670

(22) Filed: Jul. 31, 2003

(51) Int. Cl. F16D 41/12

(52) U.S. Cl. 192/64; 192/46

(57) ABSTRACT

A ratchet pawl of flywheel is disclosed. The present invention relates to a cap structure of a chafing cup. The ratchet pawl of flywheel comprises a wheel seat mounted with a ratchet block module constituted from ratchet blocks, and being inserted with a teeth disc, the inner edge of the teeth disc formed into a series of ratchet teeth corresponding to the ratchet module, characterized in that the external edge of the wheel seat corresponding to the ratchet module is provided with a first and a second teeth slot, wherein the first and the second teeth slot are respectively constituted by three equilateral teeth slot, and the first and the second teeth slot are respectively spaced apart, the external edge of the wheel seat is provided with a first and second ring slot crossed over the middle section of the first and the second teeth slot; the first and the second teeth slot of the wheel seat are provided with ratchet block for the first and the second ratchet block module, and the middle section of the individual ratchet block utilizes a first and a second binding ring to mount the ratchet block of the first and the second ratchet block module on the interior of the first and the second teeth slot.

### BACKGROUND OF THE INVENTION

(a) Technical Field of the Invention

The present invention relates to braking action of a ratchet pawl of flywheel. More particularly, the two spaced apart ratchet block module mounted on the wheel seat and the different inclination angle of the ratchet block module causes the power force to increase in the course of the driving of the teeth disc. The distance of free rotation is reduced and there the longevity of the flywheel ratchet pawl is increased.

(b) Description of the Prior Art

FIG. 1 shows a conventional flywheel ratchet pawl used in bicycles or exercycles. A wheel seat 10 is provided with a ratchet pawl module which has three equidistant teeth slots 11 formed on the wheel seat 10. The external edge of the wheel seat 10 is provided with a ring slot 100 across the teeth slot 11. The teeth slots 11 are respectively mounted with ratchet block 12 having engaging slot 120. A binding ring 13 is used to bind the individual ratchet blocks 12 within the ring slot 100 and the engaging slot 120 of the ratchet block 12 to the corresponding teeth slot 11. On the wheel seat 10, a wheel cover 19 is mounted with a teeth disc 15. The inner edge of the teeth disc 15 is formed into a series of ratchet teeth 16 corresponding to the ratchet block 12, so that the ratchet block 12 of the wheel seat 10 is engaged with the teeth disc 15. The teeth disc 15 and the wheel seat 10 and the wheel cover 19 are provided with beads so as to maintain smooth rotating.

When a reverse force is exerted onto the teeth disc 15, gap is formed between the individual blocks 12 and the top edge of the ratchet teeth 16. Thus, the end section of the individual block 12 will be lifted upward and the teeth disc 15 will drive the wheel seat 10. When the force exerted to the teeth disc 15 is in a clockwise direction, the ratchet block 12, affected by the reducing ratchet teeth 16, will be withdrawn into the teeth slot 11, and the teeth disc 15 and the wheel seat 10 become to rotate freely.

As shown in FIGS. 2 and 3, when the binding ring 13 triggers three ratchet blocks 12, if the A point of any ratchet block 12 is higher or lower than the inner edge of the binding ring 13, the binding ring 13 will be automatically adjusted and become simultaneously in contact, as shown in FIGS. 2A and 3A. As shown in FIGS. 2B and 3B, the binding ring cannot simultaneously contact all the ratchet blocks 12 and gaps x, y will form at the inner edge of the binding ring 13 and the ratchet block 12. Thus, the force that exerted is not even.

In order to prolong the longevity of the binding ring 13, the binding ring is undergone a thermal treatment so that the binding ring cannot be formed into true circular. As shown in FIG. 4, only the three ratchet blocks 12 of the same design can be adjusted with respect to the tolerance. If the ratchet block 12 is more than three, a gap 2 is formed at the inner edge of the binding ring 13 and the ratchet block 12A point, and cannot be simultaneously stopped the ratchet teeth 16 of the teeth disc 15. As a result the ratchet teeth 16 is easily damaged and the action is not exact.

In view of the drawbacks of the conventional flywheel ratchet pawl, it is imperatively to improve the force of driving or to shorten the distance of free rotation. As a result, the number of the ratchet blocks is increased. However, if the ratchet block is increased, the situation of FIGS. 2B, 3B and 4B will be occurred. As a result, it is a main object of the present invention to provide a ratchet pawl of flywheel which mitigates the above drawbacks.

### SUMMARY OF THE INVENTION

Accordingly, it is an object of the present invention to provide a ratchet pawl of flywheel having a wheel seat mounted with a ratchet block module constituted from ratchet blocks, and being inserted with a teeth disc, the inner edge of the teeth disc formed into a series of ratchet teeth corresponding to the ratchet module, characterized in that the external edge of the wheel seat corresponding to the ratchet module is provided with a first and a second teeth slot, wherein the first and the second teeth slot are respectively constituted by three equilateral teeth slot, and the first and the second teeth slot are respectively spaced apart, the external edge of the wheel seat is provided with a first and second ring slot crossed over the middle section of the first and the second teeth slot; the first and the second teeth slot of the wheel seat are provided with ratchet block for the first and the second ratchet block module, and the middle section of the individual ratchet block utilizes a first and a second binding ring to mount the ratchet block of the first and the second ratchet block module on the interior of the first and the second teeth slot.

A further object of the present invention is to provide a ratchet pawl of flywheel, wherein one third of the width of the teeth slot between the first and the second teeth slot is alternately arranged, reducing the structural space.

Yet a further object of the present invention is to provide a ratchet pawl of flywheel, wherein the second teeth slot of the wheel seat is positioned between the two neighbouring first teeth slots, and the individual teeth slots of the first and the second teeth slot are provided with equal angle.

Still another object of the present invention is to provide a ratchet pawl of flywheel, wherein the second teeth slot is positioned between the two neighbouring first teeth slot biased at a position half of the ratchet teeth width and the ratchet block of the neighbouring first and the second ratchet block module are formed into different inclination angle so as to reduce the distance of the reverse rotation of the teeth disc.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded view of a conventional ratchet pawl of flywheel.

FIG. 2A is a schematic view showing the action of a conventional ratchet pawl of flywheel, depicting three ratchet blocks, the action point of the ratchet block lowered the internal diameter of the binding ring.

FIG. 2B is a schematic view of a conventional ratchet pawl module, depicting four ratchet blocks, the action point lowered the internal diameter of the binding ring.

FIG. 3A is a schematic view of a conventional ratchet pawl module, depicting three ratchet blocks, the action point of the ratchet block being higher than the internal diameter of the binding ring.

FIG. 3B is a schematic view of a conventional ratchet pawl module, depicting four ratchet blocks, the action point of the ratchet blocks being higher than the internal diameter of the binding ring.

FIG. 4A is a schematic view of a conventional ratchet pawl module, depicting three ratchet blocks, the binding ring being not a real circle.

FIG. 4B is a schematic view of a conventional ratchet pawl module, depicting four ratchet blocks, the binding ring being not a real circle.

FIG. 5 is a perspective exploded view of a ratchet pawl of flywheel in accordance with the present invention, depicting the corresponding position of the individual components.

FIG. 6 is a schematic view of the ratchet pawl of flywheel in accordance with the present invention, illustrating the actual operation of the flywheel ratchet pawl.

FIG. 7 is a perspective exploded view of a preferred embodiment of a flywheel ratchet pawl in accordance with the present invention.

FIG. 8 is a schematic view of a preferred embodiment of a flywheel ratchet pawl in accordance with the present invention.

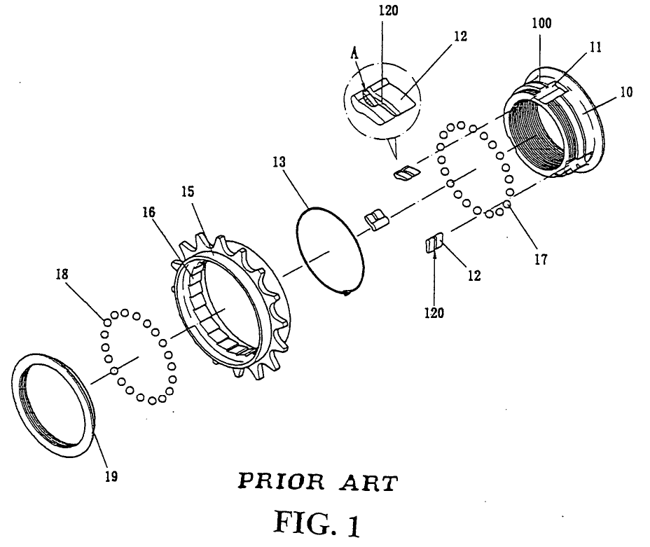

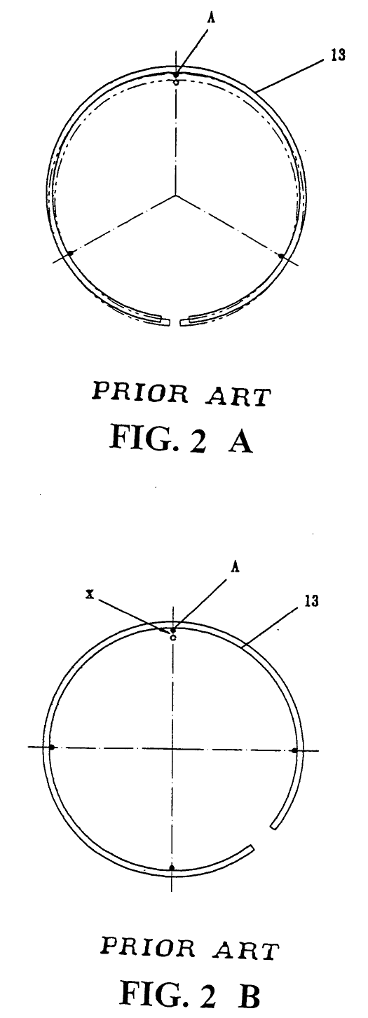

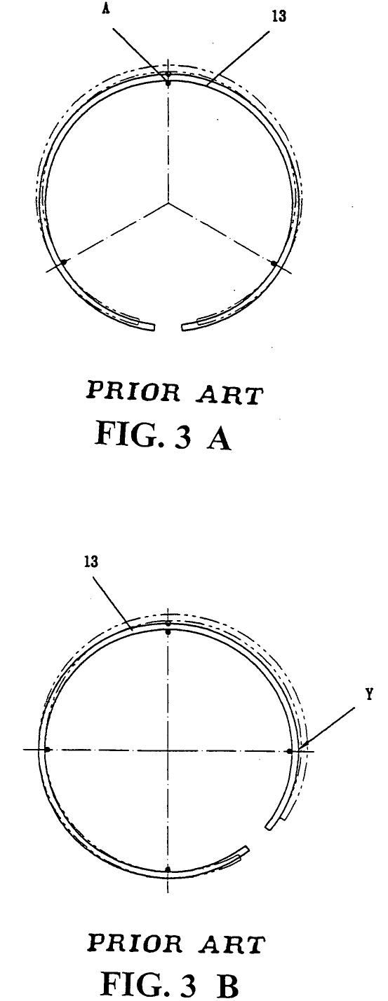

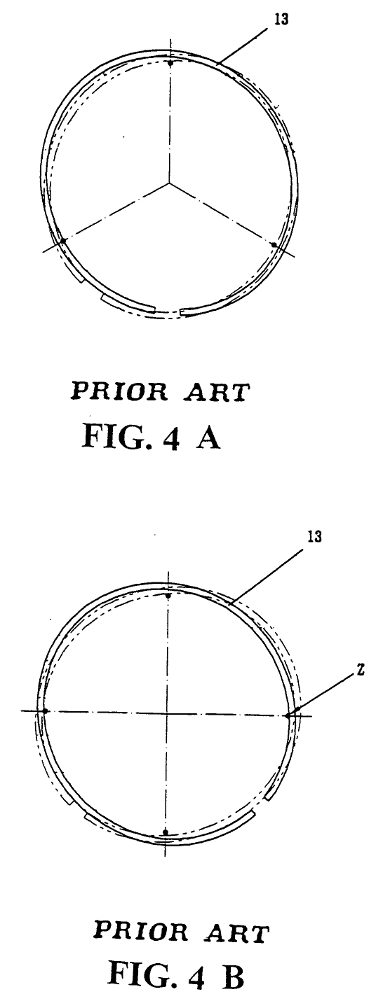

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

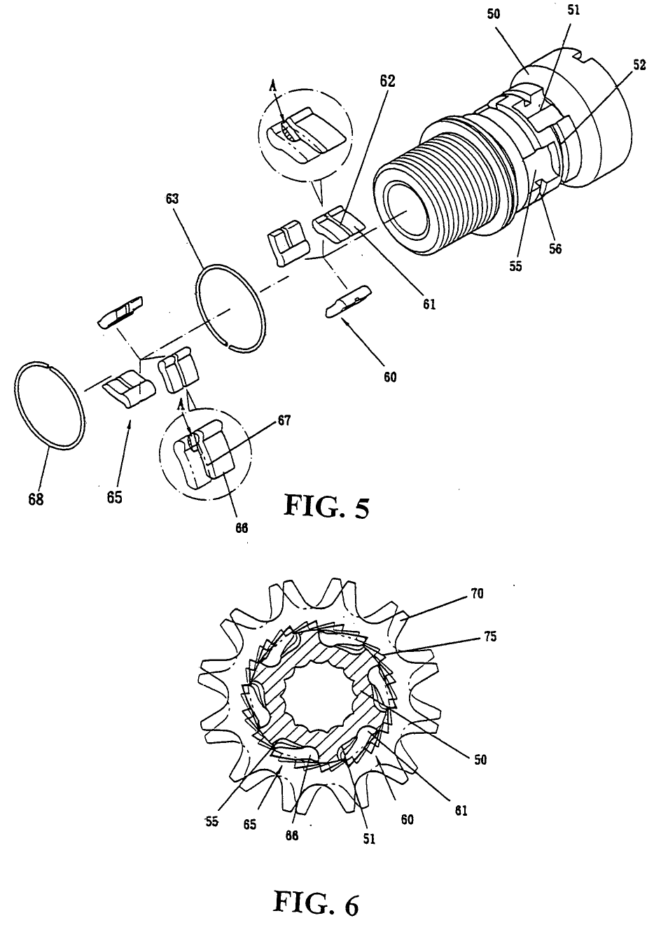

Referring to FIG. 5, the ratchet pawl of flywheel of the present invention having a wheel seat 50 mounted with ratchet block module 60, 65 constituted from ratchet blocks 61, 66, and being inserted with a teeth disc 70. The external edge of the wheel seat 50 corresponding to the teeth disc 70 is provided with a first 51 and a second teeth slot 55, wherein the first and the second teeth slot 51, 55 are respectively constituted by three equilateral teeth slot, and the first and the second teeth slot 51, 55 are respectively spaced apart. The external edge of the wheel seat 50 is provided with a first and second ring slot 52, 57 crossed over the middle section of the first and the second teeth slot 51, 55.

The first and the second teeth slot 51, 55 of the wheel seat 50 are provided with ratchet block 61, 66 for the first and the second ratchet block module 60, 65, and the middle section of the individual ratchet block 61, 66 utilizes a first and a second binding ring 63, 68 to mount the ratchet block 61, 66 of the first and the second ratchet block module 60, 65 on the interior of the first and the second teeth slot 51, 55.

In accordance with the present invention, the first and the second ratchet block module 60, 65 are respectively mounted on the wheel block 50 and the teeth disc 70 having ratchet teeth 75 at the inner edge are mounted on to the first and the second ratchet block module 60, 65. The teeth disc 70 via the first and the second ratchet block module 60, 65 to drive the wheel seat 50.

Referring to FIGS. 5 and 6, there is shown a ratchet pawl for flywheel having a wheel seat 50 and a teeth disc 70. When the teeth disc 70 of the flywheel pawl module needs to drive the wheel seat 50, the teeth disc 70 is caused to rotate anticlockwise. Thus, the individual blocks 61, 66 of the first and the second ratchet block modules 60, 65 on the wheel seat 50 can be affected by the contraction of the first and the second binding ring 63, 68. The end portions of the individual ratchet blocks 61, 66 will automatically bend upward such that the first and the second ratchet block modules 60, 65 can simultaneously brake the teeth disc 70. Thus, the teeth disc 70 will drive the wheel seat 50. Due to the fact that there are ratchet blocks 61, 66 of the first and the second ratchet block module 60, 65 to be driven simultaneously, the driven force is greatly increased. At the same time, the movement is real. In other words, the driven force is equally distributed by more ratchet blocks 61, 66. Damages on the ratchet blocks 61, 66 are avoided and the longevity of ratchet blocks 61, 66 are extended.

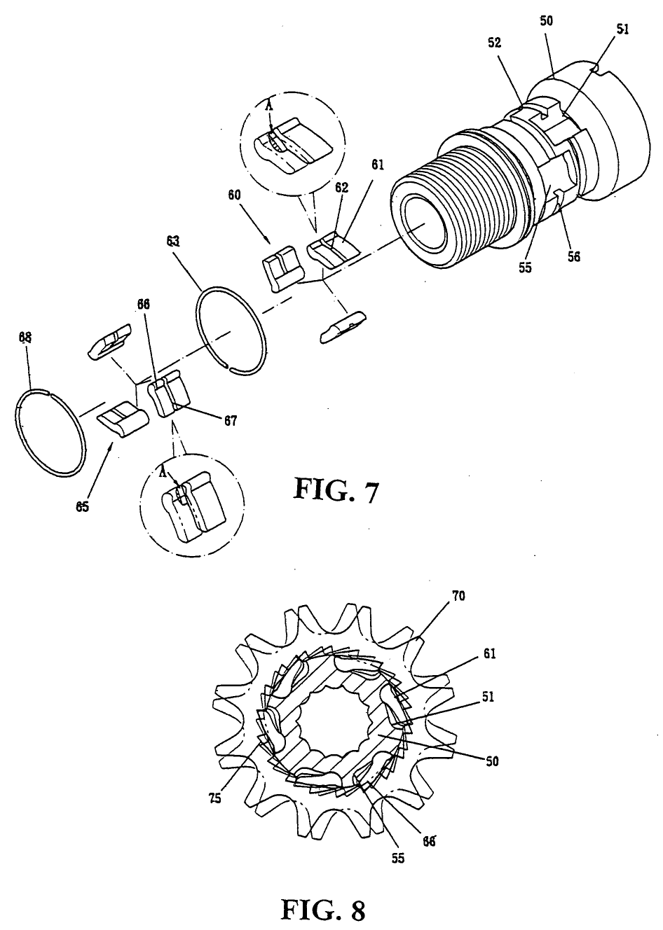

FIGS. 7 and 8 show another preferred embodiment of the ratchet pawl for flywheel in accordance with the present invention. The individual second teeth slot 55 on the wheel seat 50 positioned between two neighboring first teeth slot 51 move forward or backward to the half of the width of the ratchet teeth 75, and the ratchet blocks 61, 66 of the neighboring first and the second ratchet block modules 60, 65 form into different inclination angle. Thus, when the teeth disc 70 rotates freely and needs to reverse rotate, and the ratchet block 61 of the first ratchet block module 60 and the ratchet teeth 75 are in engagement, the other ratchet block 66 of the second ratchet block module 65 is at a half status with the ratchet teeth 75, and vise versa, when the ratchet block 61 of the first ratchet block module 60 and the ratchet teeth 75 forms into a half status, the ratchet block 66 of the first ratchet block 65 can appropriately engage with the ratchet teeth 75, without the need to go through the distance of reverse rotation.

In view of the above, the relative distance of the reverse rotation of the teeth disc 70 of the present invention with the wheel seat 70 is reduced to within the scope of half of the ratchet teeth 70. The generated impact force is small and the ratchet teeth 75, ratchet blocks 61, 66 will not affect by the impact force and therefore the longevity is increased. Furthermore, the reverse rotation distance is short, the rate of reaction is rapid and the response to start is fast, and at the same time, there is no loss of transmission force when stepping.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A ratchet pawl of flywheel having a wheel seat mounted with a ratchet block module constituted from ratchet blocks, and being inserted with a teeth disc, the inner edge of the teeth disc formed into a series of ratchet teeth corresponding to the ratchet module, characterized in that:
the external edge of the wheel seat corresponding to the ratchet module is provided with a first and a second teeth slot, wherein the first and the second teeth slot are respectively constituted by three equilateral teeth slot, and the first and the second teeth slot are respectively spaced apart, the external edge of the wheel seat is provided with a first and second ring slot crossed over the middle section of the first and the second teeth slot;
the first and the second teeth slot of the wheel seat are provided with ratchet block for the first and the second ratchet block module, and the middle section of the individual ratchet block utilizes a first and a second binding ring to mount the ratchet block of the first and the second ratchet block module on the interior of the first and the second teeth slot.

2. The ratchet pawl of flywheel of claim 1, wherein one third of the width of the teeth slot between the first and the second teeth slot is alternately arranged, reducing the structural space.

3. The ratchet pawl of flywheel of claim 1, wherein the second teeth slot of the wheel seat is positioned between the two neighboring first teeth slots, and the individual teeth slots of the first and the second teeth slot are provided with equal angle.

4. The ratchet pawl of flywheel of claim 1, wherein the second teeth slot is positioned between the two neighboring first teeth slot biased at a position half of the ratchet teeth width and the ratchet block of the neighboring first and the second ratchet block module are formed into different inclination angle so as to reduce the distance of the reverse rotation of the teeth disc.
